(19) United States
(12) Patent Application Publication
(10) Pub. No.: US 2018/0046250 A1
(43) Pub. Date: Feb. 15, 2018

(54) SYSTEM AND METHOD FOR PROVIDING AND MODULATING HAPTIC FEEDBACK

(71) Applicant: Wipro Limited, Bangalore (IN)

(72) Inventors: Sindhu BHASKARAN, Bangalore (IN); Jijith Nadumuri RAVI, Bangaluru (IN); Raja Sekhar Reddy SUDIDHALA, Bangalore (IN)

(21) Appl. No.: 15/276,846

(22) Filed: Sep. 27, 2016

(30) Foreign Application Priority Data
Aug. 9, 2016 (IN) 201641027229

(51) Int. Cl. G06F 3/01; G06T 7/40; G06F 3/041; G06T 17/00

(52) U.S. Cl. CPC G06F 3/016; G06T 17/00; G06T 7/40; G06F 3/041; G06T 2207/30108

(57) ABSTRACT

This disclosure relates generally to augmented reality and more particularly to a system and method for providing and modulating haptic feedback.

In one embodiment, a Haptic Feedback Device for providing and modulating haptic feedback is disclosed. The Haptic Feedback Device comprises a processor and a memory communicatively coupled to the processor. The memory stores processor instructions, which, on execution, causes the processor to receive a 3D Model of a product based on at least one of a visual representation and a textual description associated with the product. The processor further provides haptic feedback based on one or more 3D surface points associated with the 3D Model. The processor further modulates the haptic feedback based on a texture associated with the product, wherein the texture associated with the product is based on at least one of the visual representation and the textual description associated with the product.

### PRIORITY CLAIM

This U.S. patent application claims priority under 35 U.S.C. § 119 to: Indian Patent Application No. 201641027229, filed on Aug. 9, 2016. The aforementioned applications are incorporated herein by reference in their entirety.

### TECHNICAL FIELD

This disclosure relates generally to augmented reality and more particularly to a system and method for providing and modulating haptic feedback.

### BACKGROUND

In recent times, e-commerce has increased multifold. The new age consumer may prefer to buy online than to go through the hassle of standing in a queue and having limited choices to choose from. E-commerce has widened its range from books, music, movies to electronics, appliances, furniture, apparel and other broad categories.

Usually, the customers may not be able to physically evaluate the product, by touching, feeling, or weighing the product. For instance, a potential customer may want to touch or weigh a gown to comprehend how it may feel when the potential customer wears it. There may be devices such as tactile and kinesthetic devices that may recreate the touch, feel or weight etc., thereby affording an enhanced human/machine interface. However, currently, there is no mechanism to convert the commonly available information associated with a product, to tactile data and kinesthetic data so that it may be rendered on to the tactile and kinesthetic devices.

### SUMMARY

In an embodiment, the present disclosure illustrates a method of providing and modulating haptic feedback. The method comprises, receiving a 3-Dimensional (3D) Model of a product based on at least one of a visual representation and a textual description associated with the product. The method further comprises providing haptic feedback based on one or more 3D surface points associated with the 3D model. The method further comprises modulating the haptic feedback based on a texture associated with the product, wherein the texture is based on at least one of the visual representation and the textual description associated with the product.

In another embodiment, a system for providing and modulating haptic feedback is disclosed. The system comprises a processor and a memory communicatively coupled to the processor. The memory stores processor instructions, which, on execution, causes the processor to receive a 3D Model of a product based on at least one of a visual representation and a textual description associated with the product. The processor further provides haptic feedback based on one or more 3D surface points associated with the 3D Model. The processor further modulates the haptic feedback based on a texture associated with the product, wherein the texture is based on at least one of the visual representation and the textual description associated with the product.

In yet another embodiment, a non-transitory computer-readable storage medium for providing and modulating haptic feedback is disclosed, which when executed by a computing device, causes the computing device to: receive a 3D model of a product based on at least one of a visual representation of the product and a textual description associated with the product; provide haptic feedback based on one or more 3D surface points associated with the 3D model, to a user; and modulate the haptic feedback based on a texture associated with the product, wherein the texture associated with the product is based on at least one of the visual representation of the product and the textual description associated with the product;

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary network implementation comprising a Haptic Feedback Device for providing and modulating haptic feedback, according to some embodiments of the present disclosure.

FIG. 2 illustrates an exemplary method of providing and modulating haptic feedback, in accordance with some embodiments of the present disclosure.

FIG. 3 is a block diagram of an exemplary computer system for implementing embodiments consistent with the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The present subject matter discloses a method and system for providing and modulating haptic feedback. The system and method may be implemented in a variety of computing systems. The computing systems that can implement the described method(s) include, but are not limited to a server, a desktop personal computer, a notebook or a portable computer, hand-held devices, and a mainframe computer. Although the description herein is with reference to certain computing systems, the system and method may be implemented in other computing systems, albeit with a few variations, as will be understood by a person skilled in the art.

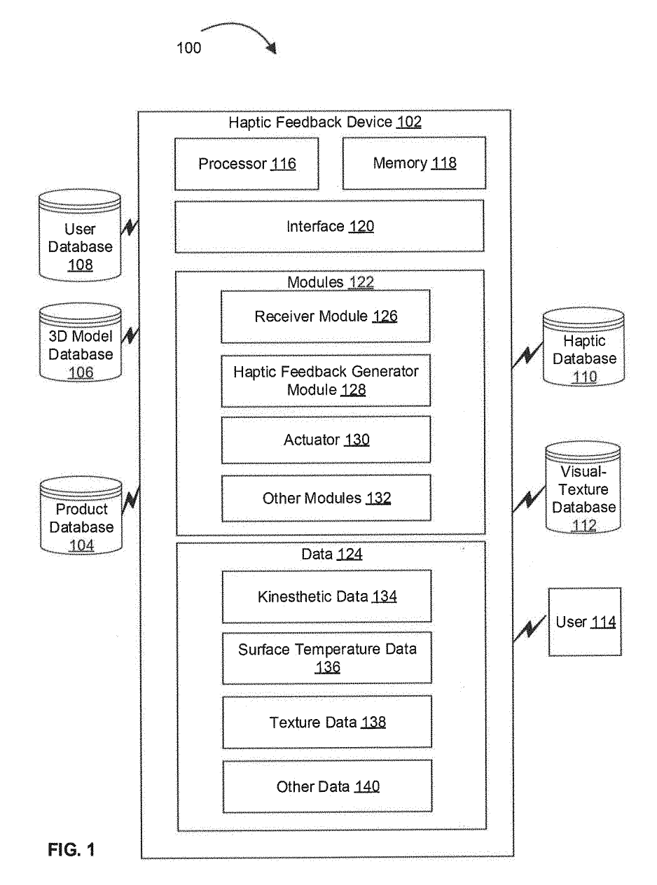

Working of the systems and methods for providing and modulating haptic feedback is described in conjunction with FIG. 1-3. It should be noted that the description and drawings merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and are to be construed as being without limitation to such specifically recited examples and conditions. Moreover, all statements herein reciting principles, aspects, and embodiments of the present subject matter, as well as specific examples thereof, are intended to encompass equivalents thereof. While aspects of the systems and methods can be implemented in any number of different computing systems environments, and/or configurations, the embodiments are described in the context of the following exemplary system architecture(s).

FIG. 1 illustrates an exemplary network environment 100 comprising a Haptic Feedback Device 102, in accordance with some embodiments of the present disclosure. As shown in FIG. 1, the Haptic Feedback Device 102 is communicatively coupled to a Product Database 104, a 3D Model Database 106, a User Database 108, a Haptic Database 110, a Visual-Texture Database 112 and a User 114. Although the Product Database 104, the 3D Model Database 106, the User Database 108, the Haptic Database 110, and the Visual-Texture Database 112 is shown external to the Haptic Feedback Device 102 in FIG, 1, it may be noted that in one implementation, the Product Database 104, the 3D Model Database 106, the User Database 108, the Haptic Database 110, and the Visual-Texture Database 112 may be present within the Haptic Feedback Device 102.

The Product Database 104 comprises at least one of a visual representation and a textual description associated with a product. The product may be available in an e-commerce environment, which may be available to a potential customer. The Product Database 104 may be populated by using the data provided by at least one of products' websites, merchant websites or product comparison websites. The User Database 108 comprises at least one of user feedback or user suggestions. The Haptic Database 110 comprises at least one of tactile data and kinesthetic data associated with the product. The Visual-Texture Database 112 comprises at least one of the visual representation associated with the product and a corresponding predefined texture associated with the product.

The Haptic Feedback Device 102 may be communicatively coupled to the Product Database 104, the 3D Model Database 106, the User Database 108, the Haptic Database 110 and the Visual-Texture Database 112 through a network. The network may be a wireless network, wired network or a combination thereof. The network can be implemented as one of the different types of networks, such as intranet, local area network (LAN), wide area network (WAN), the internet, and such. The network may either be a dedicated network or a shared network.

As shown in FIG.1, the Haptic Feedback Device 102 comprises a processor 116, a memory 118 coupled to the processor 116 and interface(s) 120. The processor 116 may be implemented as one or more microprocessors, microcomputers, microcontrollers, digital signal processors, central processing units, state machines, logic circuitries, and/or any devices that manipulate signals based on operational instructions. Among other capabilities, the processor 116 is configured to fetch and execute computer-readable instructions stored in the memory 118. The memory 118 can include any non-transitory computer-readable medium known in the art including, for example, volatile memory (e.g., RAM), and/or non-volatile memory (e.g., EPROM, flash memory, etc.).

The interface(s) 120 may include a variety of software and hardware interfaces, for example, a web interface, a graphical user interface, etc., allowing the Haptic Feedback Device 102 to interact with user devices. Further, the interface(s) 120 may enable the Haptic Feedback Device 102 to communicate with other computing devices.

In one example, the Haptic Feedback Device 102 includes modules 122 and data 124. In one embodiment, the modules 122 and the data 124 may be stored within the memory 118. In one example, the modules 122, amongst other things, include routines, programs, objects, components, and data structures, which perform particular tasks or implement particular abstract data types.

In one implementation, the modules 122 include a receiver module 126, a Haptic Feedback Generator Module 128 and an Actuator 130. In an example, the modules 124 may also comprises other modules 132. The other modules 132 may perform various miscellaneous functionalities of the Haptic Feedback Device 102. It will be appreciated that such aforementioned modules 122 may be represented as a single module or a combination of different modules.

In one example, the data 124 serves, among other things, as a repository for storing data fetched, processed, received and generated by one or more of the modules 122. In one implementation, the data 124 may include kinesthetic data 134, surface temperature data 136 and texture data 138. In one embodiment, the data may be stored in the memory 118 in the form of various data structures. In an example, the data 124 may also comprise other data 140 used to store data including temporary data and temporary files, generated by the modules 122 for performing the various functions of the Haptic Feedback Device 102.

The kinesthetic data 134 comprises at least one of weight, pressure, force, density or impulse. The surface temperature data 136 means the surface temperature associated with the product and is based on the textual description associated with the product. The texture data 138 comprises at least one of metal, glass, wooden, cloth, plastic, rough or smooth.

In order to generate haptic feedback, a 3D Model of the product may be received from a 3D Model Database 106, by the receiver module 126. In one embodiment, the 3D Model of the product may be directly available in the products' website or related websites. In other embodiments, the 3D Model may be generated. Generation of the 3D model may be based on the visual representation and textual description associated with the product. For instance, the 3D Model of the product may be obtained from 3D Model warehouses like Google warehouses, T3DFM, Turbosquid etc. The 3D model may also be generated by employing software tools.

Once the 3D Model of the product has been received, haptic feedback may be provided based on one or more 3D surface points associated with the 3D Model of the product, by the Haptic Feedback Generator Module 128. Tessellation may be used to generate a 3D mesh from the 3D model of the product. The 3D mesh may comprise the 3D surface points and edges connecting the 3D surface points. A haptic signal may be generated by the processor 116, based on the 3D surface points.

The haptic signal generated by the Processor 116 may be communicated to an Actuator 130. In one embodiment, the Actuator 130 may be an Eccentric Rotating Mass (ERM) actuator. The ERM actuator, which may be similar to a Direct Current (DC) motor, may comprise at least one rotating mass, which may be rotating off center from the point of rotation. The uneven centripetal force may generate lateral vibrations in the ERM actuator. The haptic signal flowing through windings attached to shaft of the ERM actuator, may generate a magnetic field, which may apply a force to the rotating mass. The force may be directly proportional to the haptic signal flowing through the windings. Hence, vibration produced by the ERM actuator may be based on the haptic signal. In another embodiment, the Actuator 130 may be a Linear Resonant Actuator (LRA). In LRA a voice coil may be used instead of a DC motor. Input to the voice coil may be an alternating current. LRA may provide vibrations based on frequency and amplitude of the haptic signal.

Providing the haptic feedback may also entail creating a 3D model associated with a hand of the user 114. The 3D model of the hand along with the 3D model of the Haptic Feedback Device 102 may be created. One or more 3D surface points associated with the hand of the user 114 may be derived from the 30 model associated with the hand of the user 114, using tessellation. When the 3D surface points associated with the hand of the user touches the 3D surface points associated with the product, a haptic signal may be generated. The haptic signal may be communicated to the Actuator 130 of the Haptic Feedback Device 102.

Once the haptic feedback is provided, the haptic feedback may be modulated by the Haptic Feedback Generator Module 128, based on a texture associated with the product. The texture associated with the product may be determined based on at least one of the visual representation and the textual description associated with the product. The texture may be determined by looking up the Visual-Texture Database 112 with the visual representation of the product. The Visual-Texture Database 112 may comprise at least one of the visual representation and a corresponding predefined texture associated with the product. The predefined texture comprises at least one of metal, glass, wooden, cloth, plastic, rough or smooth.

In one embodiment, if the texture is not available in the Visual-Texture Database 112, it may be generated by using Image processing technique on the visual representation of the product. For instance, it may be generated by determining the noise level in the image and determining the texture based on the determined noise level. In another embodiment, the texture associated with the Visual-Texture Database 112 may be updated by using a self-learning Artificial Intelligence (Al) Engine (not shown in FIG.). The self-learning Al engine (not shown in FIG.) may learn from at least one of historical data, user feedbacks or user suggestions. The user feedbacks and the user suggestions may be provided by the User Database 108. In one embodiment, several user feedbacks may be analyzed to determine general trend of the user feedbacks. For instance, if the general trend of user feedback opines that a particular wooden product feels too smooth, then the Visual-Texture Database 112 may be updated by changing the texture corresponding to the wooden product, to be rougher. The determined texture may be stored in the Haptic Database 110 and may be retrieved when there is a requirement for modulating the haptic feedback based on the texture.

The haptic feedback may further be modulated based on at least one of kinesthetic data 134 and surface temperature data 136. Modulating the haptic feedback may entail modulating at least one of intensity, frequency, or time of the haptic feedback. The kinesthetic data 134 comprises at least one of weight, pressure, force, density or impulse. The kinesthetic data 134 may be determined based on at least one of the visual representation of the product and the textual description associated with the product. In one embodiment, the kinesthetic data 134 may be readily available in the textual description. In another embodiment, volume and density of the product may be inferred from the size and shape of the image i.e. the visual representation of the product. The weight of the product, i.e. kinesthetic data 134 may be derived from the volume and the density of the product. The kinesthetic data 134 may be stored in the haptic database and retrieved, when there is a requirement to modulate the haptic feedback based on the kinesthetic data 134.

The intensity, the frequency and the time of the haptic feedback may also be modulated based on the surface temperature data 136. The surface temperature data 136 may be determined from the textual description associated with the product. There may be a Temperature Control Device (not shown in FIG.), which may control temperature of the Haptic Feedback Device 102 based on the surface temperature data 136. Controlling of the temperature may be accomplished by heating, cooling, sinking heat, dissipating or diffusing heat, activating fans or other cooling mechanisms. In one embodiment, the temperature may be controlled based on the texture of the product. For instance, heating may be done to the Haptic Feedback Device 102 if the texture is wooden. If the texture is metal, then cooling may be done to the Haptic Feedback Device 102. The Haptic Feedback Device 102 may be made of thermally conducting material. The Temperature Control Device (not shown in FIG.) may either control the temperature of the entire Haptic Feedback Device 102 or a portion of the Haptic Feedback Device 102.

In one illustration, the product available in the e-commerce environment may be a wooden jewelry box, which may be experienced by using a haptic glove. A 3D mod& of the jewelry box may be obtained from products websites or related websites like Google warehouses, T3DFM, Turbosquid etc. Tessellation may be done to convert the 3D model to a 3D mesh. From the 3D mesh, the 3D surface points associated with the jewelry box may be determined. A haptic signal in the form of an electric current may be generated based on the 3D surface points. The haptic signal may be communicated to an Actuator 130 which may provide haptic vibrations based on the haptic signal. For instance, corners of the jewelry box may generate a stronger haptic signal compared to other regions of the box, which may in effect generate stronger haptic vibrations.

The haptic vibrations may also be provided by the Haptic Glove when the 3D surface points associated with the haptic glove touches the 3D surface points associated with the jewelry box. For instance, when the user attempts to touch the corner of the jewelry box with the haptic glove, a haptic signal may be generated, the moment the 3D surface points associated with the glove, touches the 3D surface points in the corner of the jewelry box.

The intensity, the frequency and the time of the haptic vibrations may be modulated based on the texture of the jewelry box. Texture may be determined from the textual description. For instance, the textual description may describe the jewelry box to be wooden. This may help in deducing the texture of the jewelry box, i.e. the texture may be rough or wooden. The texture may be also determined by looking up the Visual-Texture Database 112 with the image of the jewelry box. The predefined texture corresponding to the image of the jewelry box may be wooden or rough. The Visual-Texture database may be updated by using a self-learning Al engine (not shown in FIG.). The previous user feedback associated with experiencing the jewelry box may be analyzed. The general opinion may be that the jewelry box feels too smooth. In this case, the database may be updated. The texture corresponding to the image of the jewelry box may be updated to a rougher texture.

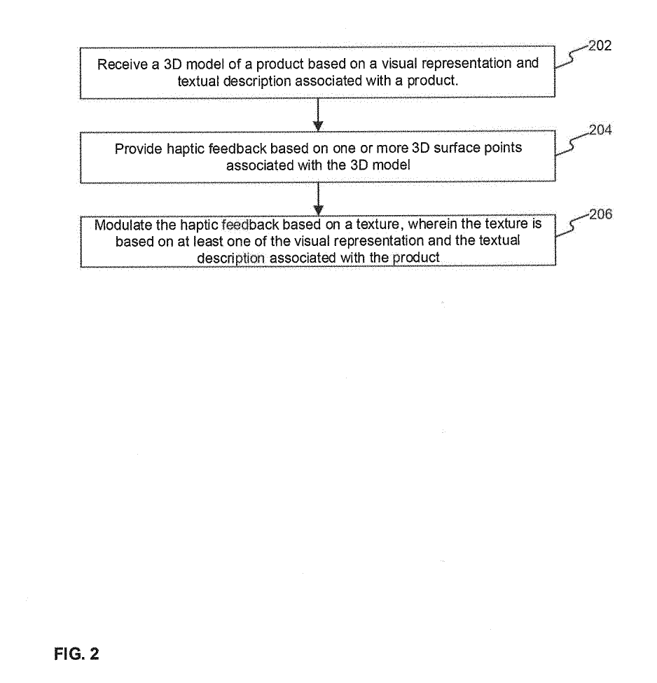

FIG. 2 illustrates an exemplary method of providing and modulating haptic feedback. A 3D model of a product may be received at step 202. The 3D model of the product may be determined from a visual representation and a textual description associated with the product. The 3D model may also be generated by employing software tools. The 3D model may also be directly available in at least one of product websites, merchant websites or product comparison websites.

After receiving the 3D model, haptic feedback may be provided, based on one or more 3D surface points associated with the 3D model of the product, at step 204. A 3D mesh may be created by tessellating the 3D model of the product. The 3D mesh may comprise the 3D surface points and edges connecting the 3D surface points. The Processor 116 may determine a haptic signal based on the 3D surface points. The haptic signal may be communicated to an Actuator 130 associated with the Haptic Feedback Device 102 such as haptic gloves, haptic shoes, kinesthetic treadmills, kinesthetic gloves, kinesthetic locomotion systems etc.

Providing the haptic feedback may also entail creating a 3D model associated with the hand of the user 114. Tessellation may be used to determine one or more 3D surface points from the 3D model associated with the hand of the user 114. A haptic signal may be generated when the 3D surface points associated with the hand of the user 114 touches the 3D surface points associated with the product.

After providing the haptic feedback it may be modulated based on a texture data 138, at step 206. The texture data 138 may be determined from at least one of the visual representation and the textual description associated with the product. The texture may be determined by looking up a Visual-Texture Database 112 with the visual representation of the product. In one embodiment, if the texture is not available in the Visual-Texture Database 112, then the texture may be generated by using Image Processing technique on the visual representation of the product. In another embodiment, when the texture associated with the Visual-Texture database 112 may be updated using a self-learning Al engine (not shown in FIG.). The self-learning Al engine (not shown in FIG.) may learn from at least one of historical data, user feedbacks or user suggestions.

The haptic feedback may further be modulated based on at least one of kinesthetic data 134 or surface temperature data 136.The kinesthetic data 134 may be determined based on at least one of the visual representation and the textual description associated with the product. The kinesthetic data 134 comprises at least one of weight, pressure, force, density or impulse. The surface temperature data 136 may be determined from the textual description associated with the product. A Temperature Control Device (not shown in FIG.) may be used to control the temperature of the Haptic Feedback Device 102 based on the surface temperature data 136. The controlling of temperature may be accomplished by heating, cooling, sinking heat, dissipating or diffusing heat, activating fans or other cooling mechanisms.

### Computer System

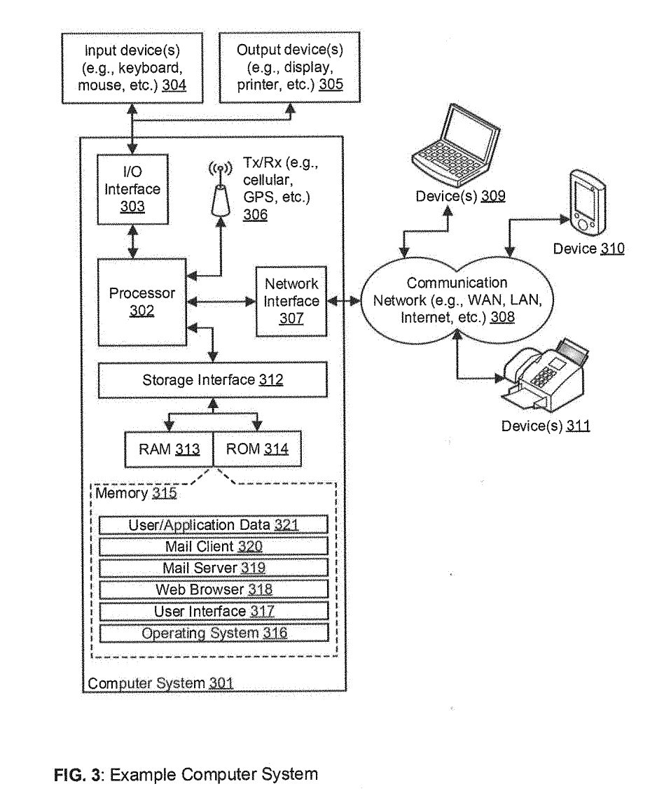

FIG. 3 is a block diagram of an exemplary computer system for implementing embodiments consistent with the present disclosure. Variations of computer system 301 may be used for implementing the modeler 118, the analyzer 120, and the prediction module 122 presented in this disclosure. Computer system 301 may comprise a central processing unit (“CPU” or “processor”) 302. Processor 302 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 302 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 302 may be disposed in communication with one or more input/output (I/O) devices via I/O interface 303. The I/O interface 303 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 303, the computer system 301 may communicate with one or more I/O devices. For example, the input device 304 may be an antenna, keyboard, mouse, joystick, (infrared) remote control, camera, card reader, fax machine, dangle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 305 may be a printer, fax machine, video display (e.g., cathode ray tube (CRT), liquid crystal display (LCD), light-emitting diode (LED), plasma, or the like), audio speaker, etc. In some embodiments, a transceiver 306 may be disposed in connection with the processor 302. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 302 may be disposed in communication with a communication network 308 via a network interface 307. The network interface 307 may communicate with the communication network 308. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 308 may include, without limitation, a direct interconnection, local area network (LAN), wide area network (WAN), wireless network (e.g., using Wireless Application Protocol), the Internet, etc. Using the network interface 307 and the communication network 308, the computer system 301 may communicate with devices 310, 311, and 312. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 301 may itself embody one or more of these devices.

In some embodiments, the processor 302 may be disposed in communication with one or more memory devices (e.g., RAM 313, ROM 314, etc.) via a storage interface 312. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 316, user interface application 317, web browser 318, mail server 319, mail client 320, user/application data 321 (e.g., any data variables or data records discussed in this disclosure), etc. The operating system 316 may facilitate resource management and operation of the computer system 301. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 317 may facilitate display, execution, interaction, manipulation, or operation of program components through textual or graphical facilities. For example, user interfaces may provide computer interaction interface elements on a display system operatively connected to the computer system 301, such as cursors, icons, check boxes, menus, scrollers, windows, widgets, etc. Graphical user interfaces (GUIs) may be employed, including. without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 301 may implement a web browser 318 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 301 may implement a mail server 319 stored program component The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMP), messaging application programming interface (MAPI), Microsoft Exchange, post office protocol (POP), simple mail transfer protocol (SMTP), or the like. In some embodiments, the computer system 301 may implement a mail client 320 stored program component. The mail client may be a mail viewing application, such as Apple Mail, Microsoft Entourage, Microsoft Outlook, Mozilla Thunderbird, etc.

In some embodiments, computer system 301 may store user/application data 321, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e,g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described systems and methods predicting occurrence of an event in an IT infrastructure. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of generating haptic feedback, the method comprising:
receiving, by a Haptic Feedback Device, a 3-Dimensional (3D) model of a product based on at least one of a visual representation of the product and a textual description associated with the product;
providing, by the Haptic Feedback Device, haptic feedback based on one or more 3D surface points associated with the 3D model, to a user; and
modulating, by the Haptic Feedback Device, the haptic feedback based on a texture associated with the product, wherein the texture associated with the product is based on at least one of the visual representation of the product and the textual description associated with the product;

2. The method as claimed in claim 1, wherein modulating the haptic feedback comprises, modulating the haptic feedback based on kinesthetic data, wherein the kinesthetic data is based on at least one of the visual representation of the product and the textual description associated with the product.

3. The method as claimed in claim 2, wherein the kinesthetic data comprises at least one of weight, pressure, force, density or impulse.

4. The method as claimed in claim 1, wherein modulating the haptic feedback further comprises modulating the haptic feedback based on a surface temperature data associated with the product, wherein the surface temperature data is based on the textual description associated with the product.

5. The method as claimed in claim 1, wherein determining the texture associated with the product comprises matching the visual representation of the product with a predefined texture from a Visual-Texture Database.

6. The method as claimed in claim 5, wherein the predefined texture comprises at least one of metal, glass, wooden, cloth, plastic, rough or smooth.

7. The method as claimed in claim 1, wherein the visual representation of the product comprises at least one of a product image and a product video.

8. The method as claimed in claim 1, wherein modulating the haptic feedback further comprises modulating at least one of an intensity, a frequency or time of the haptic feedback.

9. The method as claimed in claim 1, further comprises creating a 3D model associated with a hand of the user.

10. The method as claimed in claim 9, wherein providing the haptic feedback further comprises providing the haptic feedback when one or more 3D surface points associated with the hand of the user touches the one or more 3D surface points associated with the product, wherein the one or more 3D surface points associated with the hand of the user is based on the 3D model associated with the hand of the user.

11. A Haptic Feedback Device for generating haptic feedback, the Haptic Feedback Device comprising:
a processor;
a memory communicatively coupled to the processor, wherein the memory stores the processor-executable instructions, which, on execution, causes the processor to:
receive a 3-Dimensional (3D) model of a product based on the at least one of a visual representation of the product and a textual description associated with the product;
provide haptic feedback based on one or r pore 3D surface points associated with the 3D model, to a user; and
modulate the haptic feedback based on a texture associated with the product, wherein the texture associated with the product is based on at least one of the visual representation of the product and the textual description associated with the product;

12. The Haptic Feedback Device as claimed in claim 11, wherein the processor is configured to modulate the haptic feedback based on kinesthetic data, wherein the kinesthetic data is based on at least one of the visual representation of the product and the textual description associated with the product.

13. The Haptic Feedback Device as claimed in claim 12, wherein the kinesthetic data comprises at least one of weight, pressure, force, density or impulse.

14. The Haptic Feedback Device as claimed in claim 11, wherein the processor is further configured to modulate the haptic feedback based on a surface temperature data associated with the product, wherein the surface temperature data is based on the textual description associated with the product.

15. The Haptic Feedback Device as claimed in claim 11, wherein the processor is configured to determine the texture associated with the product by matching the visual representation of the product with a predefined texture from a Visual-Texture Database.

16. The Haptic Feedback Device as claimed in claim 15, wherein the predefined texture comprises at least one of metal, glass, wood, cloth or plastic, rough or smooth.

17. The Haptic Feedback Device as claimed in claim 11, wherein the processor is further configured to modulate the haptic feedback by modulating at least one of an intensity, a frequency or time of the haptic feedback.

18. The Haptic Feedback Device as claimed in claim 11, wherein the processor is further configured to create a 30 model associated with a hand of the user.

19. The Haptic Feedback Device as claimed in claim 19, wherein the processor is further configured to provide the haptic feedback when one or more 3D surface points associated with the hand of the user touches the one or more 3D surface points associated with the product, wherein the one or more 3D surface points associated with the hand of the user is based on the 3D model associated with the hand of the user.

20. A non-transitory computer-readable storage medium for providing and modulating haptic feedback, when executed by a computing device, causes the computing device to:
receive, by a Haptic Feedback Device, a 3-Dimensional (3D) model of a product based on at least one of a visual representation of the product and a textual description associated with the product;
provide, by the Haptic Feedback Device, haptic feedback based on one or more 3D surface points associated with the 3D model, to a user; and
modulate, by the Haptic Feedback Device, the haptic feedback based on a texture associated with the product, wherein the texture associated with the product is based on at least one of the visual representation of the product and the textual description associated with the product;
